(19) United States
(12) Patent Application Publication
(10) Pub. No.: US 2015/0004093 A1
(43) Pub. Date: Jan. 1, 2015

(54) METHOD OF REJUVENATING BIOMASS CONVERSION CHART

(71) Applicant: KiOR, Inc., Pasadena, TX (US)

(72) Inventors: Ling Zhou, Houston, TX (US); Amanda Bryant, Houston, TX (US); Maria Magdalena Ramirez, Houston, TX (US); Leslie May, Houston, TX (US); Richard A. Engelman, Midland, TX (US); Bruce Adkins, League City, TX (US); Darrell Rainer, Houston, TX (US)

(73) Assignee: KiOR, Inc., Pasadena, TX (US)

(21) Appl. No.: 13/932,794

(22) Filed: Jul. 1, 2013

(51) Int. Cl. B01J 29/90

(52) U.S. Cl. CPC B01J 29/90
USPC 423/700

(57) ABSTRACT

Spent catalyst or regenerated catalyst from a biomass conversion unit may be rejuvenated by treating at least a portion of the spent catalyst or regenerated catalyst with a treatment acid, the treatment acid comprising an inorganic acid or an organic acid or a mixture thereof.

### FIELD OF THE DISCLOSURE

The disclosure relates to a method of rejuvenating a spent catalyst or a regenerated catalyst from a biomass conversion unit wherein at least a portion of the spent catalyst or regenerated catalyst is treated with an inorganic or organic acid.

### BACKGROUND OF THE DISCLOSURE

Renewable fuel sources may be obtained by converting a biomass feedstock into useful biofuels and/or specialty chemicals. For instance, a bio-oil containing stream may be produced by subjecting a biomass feedstock to fast pyrolysis, slow pyrolysis, liquefaction, gasification, enzymatic conversion or another chemical conversion reaction in the presence of a catalyst in a biomass conversion unit.

Chemically combined minerals as well as metals (calcium, potassium, magnesium, sodium, manganese, aluminum, silicon, chromium, chlorine, iron, phosphorus, sulfur, etc.) from the biomass accumulate on the catalyst during the conversion reaction. This dramatically decreases the surface area and the micropore volume of the catalyst and markedly influences physical chemical properties and performance of the catalyst. Catalytic activity is therefore significantly decreased.

Removal of metal contaminants from spent catalyst typically requires harsh demetallization chemicals. In addition, this process is carried out ex-situ from the reaction system, and requires shutting down of the reactor, unloading the spent catalyst and then transporting the spent catalyst to a chemical processing facility.

An alternative method is needed for improving catalyst performance during conversion of biomass. Such alternatives would desirably be conducted under milder conditions than those presently offered and render restoration of the physical properties of the catalyst.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

Accordingly, there exists a need for improved methods for restoring the physical properties of a catalyst spent in a biomass conversion unit and having one or more of the attributes or capabilities described or shown in, or as may be apparent from, the other portions of this patent.

### SUMMARY OF THE DISCLOSURE

In an embodiment of the disclosure, a method of rejuvenating a spent catalyst or a regenerated catalyst from a biomass conversion unit is provided by treating at least a portion of the spent catalyst or regenerated catalyst with an acid wash comprising a treatment acid of an inorganic acid or an organic acid or a mixture thereof.

In another embodiment, a method of rejuvenating a spent catalyst or a regenerated catalyst from a biomass conversion unit is provided which includes first transporting the spent catalyst or regenerated catalyst to an area remote from the biomass conversion unit and then treating at least a portion of the spent catalyst or regenerated catalyst with a solution containing an inorganic acid. At least one contaminant metal selected from the group consisting of calcium, potassium, magnesium, manganese, sodium, aluminum, silicon, chromium, chlorine and iron is then removed or disassociated from the spent catalyst or regenerated catalyst.

In another embodiment, a method of rejuvenating a spent catalyst or a regenerated catalyst from a biomass conversion unit is provided, wherein the method is conducted in an integrated unit comprising the biomass conversion unit, a bio-oil separation and recovery unit(s), and a catalyst rejuvenation unit. In this embodiment, the biomass may first be subjected to pyrolysis in the presence of a catalyst in the biomass conversion unit and a bio-oil containing feedstream and spent catalyst is then generated. The spent catalyst may optionally be subjected to regeneration. The bio-oil and acid enriched water may then be separated from the bio-oil containing feedstream. At least a portion of the spent catalyst or the regenerated catalyst may be introduced into the catalyst rejuvenation unit. The spent catalyst or the regenerated catalyst may then be treated in the catalyst rejuvenation unit with the acid enriched water and contaminant metals in the spent catalyst or regenerated catalyst may then be removed, dispersed or disassociated to render a rejuvenated catalyst.

In yet another embodiment, a method of rejuvenating a spent catalyst or a regenerated catalyst from a biomass conversion unit is provided by first circulating in a biomass conversion unit a fresh biomass conversion catalyst and a biomass feed containing mineral metals. Spent catalyst may be generated in the biomass conversion unit from accumulation of the mineral metals in the catalyst inventory. The spent catalyst may optionally be subjected to regeneration. At least a portion of the spent catalyst and/or regenerated catalyst is treated with a solution containing an inorganic acid, an organic acid or a mixture thereof. Contaminant metals may then be removed, dispersed, or disassociated from at least a portion of the spent catalyst and/or regenerated catalyst to render rejuvenated catalyst.

Accordingly, the present disclosure includes features and advantages for rejuvenating a spent catalyst or a regenerated catalyst from a biomass conversion unit. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 illustrates a process for rejuvenating a spent catalyst and/or regenerated catalyst using a solution containing an inorganic or organic acid or a mixture thereof.

FIG. 2 illustrates an embodiment of the disclosure wherein the process of rejuvenating a spent catalyst and/or regenerated catalyst may be integrated with a biomass conversion unit.

FIG. 3 illustrates an embodiment of the disclosure, wherein the process of rejuvenating a spent catalyst and/or regenerated catalyst may be integrated with a biomass conversion unit and a bio-oil separation and recovery unit(s).

FIG. 4 illustrates the effectiveness of oxalic acid at low concentrations and short contact time in unplugging the micropores and restoring the surface area of a regenerated catalyst from a biomass conversion unit.

FIG. 5 illustrates the effectiveness of mild treatments of oxalic acid and phosphoric acid in restoring the surface area of a regenerated catalyst from a biomass conversion unit over 4 hours.

FIG. 6 illustrates the recovery of micropore volume and surface area of catalysts regenerated from a biomass conversion unit at varying total contaminant metal (TM) contents when using an organic acid wash.

FIG. 7 illustrates the effectiveness of acetic acid at low concentrations and short contact time in unplugging the micropores and restoring the surface area of a regenerated catalyst from a biomass conversion unit.

FIG. 8 illustrates the effectiveness of nitric acid at low concentrations and short contact time in unplugging the micropores and restoring the surface area of a regenerated catalyst from a biomass conversion unit.

FIG. 9 illustrates the effectiveness of produced acid enriched water from a biomass conversion unit in unplugging micropores and restoring the surface area of a regenerated catalyst.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments in the appended figures, common or similar elements may be referenced with like or identical reference numerals or are apparent from the figures and/or the description herein. The figures are not necessarily to scale and certain features and certain views of the figures may be shown exaggerated in scale or in schematic in the interest of clarity and conciseness.

Certain terms are used herein and in the appended claims to refer to particular components or steps. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Physical properties, such as micropore volume and micropore surface area, of a metal contaminated biomass conversion catalyst may be restored by the process disclosed herein wherein the catalyst is exposed to mild conditions with a treating acid solution, referred to as an acid wash. The metal contaminated catalyst subjected to the rejuvenation process disclosed herein may be a spent catalyst. The spent catalyst forms in the biomass conversion unit from the accumulation of mineral metals from the biomass in the catalyst inventory.

Alternatively, the metal contaminated catalyst subjected to the rejuvenation process may be an equilibrium catalyst (“E-cat”), also referred to as regenerated catalyst. Such catalysts are produced by burning coke deposits from a spent catalyst in oxygen or an oxygen containing gas, such as air, in a catalyst regeneration unit or regenerator. All or a portion of the spent catalyst formed in the biomass conversion unit may be subjected to treatment in the regenerator.

In an embodiment, the catalyst treated in the process disclosed herein may be a combination of the spent catalyst and regenerated catalyst. Alternatively, the catalyst treated in the process disclosed herein may be just spent catalyst or regenerated catalyst.

In the process disclosed herein, all or a portion of the metal deposits/contaminants are removed, dispersed or disassociated from the spent catalyst or regenerated catalyst. The resulting catalyst, referred to as rejuvenated catalyst, may then be reused in a biomass conversion unit, optionally with fresh biomass conversion catalyst.

The process described herein of rejuvenating spent and/or regenerated catalyst may be repeated multiple times and thus allows for multiple reactivations of the biomass conversion catalyst.

Rejuvenation of the spent catalyst and/or regenerated catalyst may be conducted in a defined chamber or by a more rudimentary design, all referred generically to herein as a rejuvenation unit. In an embodiment, the spent catalyst and/or regenerated catalyst may be rejuvenated by placing the catalyst on a moving conveyor belt and directing liquid spray nozzles of the acid wash directly onto the catalyst.

The treatment acid of the acid wash may contain one or more inorganic acids, one or more organic acids or a mixture thereof.

The inorganic acid may be one or more acids selected from nitric acid, sulfuric acid, phosphoric acid, hydrochloric acid, as well mixtures thereof.

The organic acid may be one or more acids selected from acetic acid, propionic acid, oxalic acid, uronic acid, tartaric acid, humic acid, maleic acid, citric acid, butyric acid and ascorbic acid and mixtures thereof.

In addition, the acid treatment described herein may consist of a mixture of one or more of the inorganic acids and one or more of the organic acids.

In an embodiment, the acid wash is a 0.01M to 1.0M acid solution containing the treatment acid. Other strengths of acid may be used though it is preferred that the acid wash be a weak acid solution of the treatment acid.

In an embodiment, the catalyst subjected to the rejuvenation process disclosed herein may comprise a solid acid, such as a zeolite. Examples of suitable zeolites include ZSM-5, mordenite, beta, ferrierite, and zeolite-Y. Additionally, the catalyst may comprise a super acid. Examples of suitable super acids include sulfonated, phosphated, or fluorinated forms of zirconia, titania, alumina, silica-alumina, and/or clays.

In another embodiment, the catalyst may comprise a solid base. Examples of suitable solid bases include metal oxides, metal hydroxides, and/or metal carbonates. In particular, the oxides, hydroxides, and carbonates of alkali metals, alkaline earth metals, transition metals, and/or rare earth metals are suitable. Other suitable solid bases are layered double hydroxides, mixed metal oxides, hydrotalcite, clays, and/or combinations thereof.

In yet another embodiment, the catalyst can also comprise an alumina.

Rejuvenation of spent catalyst and/or regenerated catalyst does not appreciably affect the active metal elements on the catalyst or the support of the catalyst.

The process of rejuvenating spent catalyst and/or regenerated catalyst as described herein typically occurs when the accumulated mineral metals constitute less than 50 volume percent of the catalyst inventory in the biomass conversion unit.

The spent catalyst and/or regenerated catalyst is typically subjected to the acid wash when the micropore volume or micropore surface area of the spent or regenerated catalyst has been reduced in more than 50% of the fresh biomass cracking catalyst.

The process of rejuvenation is typically achieved when the micropore volume or the micropore surface area of the rejuvenated catalyst is at least 80% of the micropore volume or the micropore surface area of the fresh biomass cracking catalyst. In many instances, the micropore volume or the micropore surface area of the rejuvenated catalyst is close to 100% and in some cases even higher.

The biomass contains mineral metals which may include calcium, magnesium, sodium, manganese, potassium, aluminum, silicon, chromium, chlorine and iron. Such mineral metals accumulate in the catalyst inventory during treatment of the biomass in the biomass conversion unit. Spent catalyst comprises such metals deposited onto the catalyst. Micropores as well as the surface area of the catalyst are plugged by such deposits in the biomass conversion unit. During rejuvenation, such metals may be removed, dispersed or disassociated from the spent catalyst or regenerated catalyst.

The biomass may be in a solid or finely divided form or may be a liquid. The biomass may be in the form of fibrous solid particles, such as cellulosic materials. Examples of suitable cellulose-containing materials include algae, paper waste, and/or cotton linters. In one embodiment, the biomass particles can comprise a lignocellulosic material. Examples of suitable lignocellulosic materials include forestry waste such as wood chips, wood slag, saw dust, pulping waste, bark, and tree branches; agricultural waste such as corn stover, wheat straw, and bagasse; and/or energy crops such as eucalyptus, switch grass, and coppice; as well as municipal water, such as yard waste, paper and cardboard. The biomass may also be lignins or hemicelluloses.

In the biomass conversion unit, the biomass may be subjected to any of a variety of conversion reactions in order to produce bio-oil. Such conversion reactions include fast pyrolysis, slow pyrolysis, liquefaction, catalytic gasification, thermocatalytic conversion, etc. Biomass conversion unit may include, for example, a fluidized bed reactor, a cyclone reactor, an ablative reactor, or a riser reactor. In a biomass conversion unit, solid biomass particles may be agitated, for example, to reduce the size of particles. Agitation may be facilitated by a gas including one or more of air, steam, flue gas, carbon dioxide, carbon monoxide, hydrogen, and hydrocarbons such as methane. The agitator further be a mill (e.g., ball or hammer mill) or kneader or mixer.

Typically, the biomass conversion unit is operated at temperatures in excess of 450° C. In some conversion reactions, such as fast pyrolysis, where the biomass is exposed to short contact times and rapid heating, reaction temperatures may be as high as 1,000° C.

Prior to and/or after treatment of the spent catalyst or the regenerated catalyst with the acid wash in the rejuvenation unit, the catalyst may be processed to remove particulates of smaller particle size. Fines enriched with all or some of the mineral metals are removed during processing.

In an embodiment, fines less than 60 μm may be removed from the spent catalyst and/or regenerated catalyst prior to and/or after subjecting the catalyst to the acid wash. In another embodiment, fines less than 45 μm may be removed from the spent catalyst and/or regenerated catalyst.

In an embodiment, rejuvenation of the spent catalyst and/or regenerated catalyst may occur in a rejuvenation unit which is not integrated with the biomass conversion unit. Thus, for instance, the rejuvenation unit may not share a direct or indirect flow line with the biomass conversion unit. Alternatively, rejuvenation of the spent catalyst and/or regenerated catalyst may occur off site from the biomass conversion unit.

In another embodiment, rejuvenation of the spent catalyst and/or regenerated catalyst may be integrated with the biomass conversion unit. In this embodiment, the spent catalyst and/or regenerated catalyst may be rejuvenated in line (in-situ) with the biomass conversion unit wherein one or more flow lines from the biomass conversion unit are fed directly into the rejuvenation unit or indirectly into the rejuvenation unit. Since the biomass conversion unit and rejuvenation chamber constitute an integrated biomass treatment unit, distinct advantages are offered to the operator. Most notably, the process disclosed herein results in less downtime, lower environmental impact, lower reactor temperatures, and longer cycle lengths of the biomass conversion unit.

In another embodiment, rejuvenation of the spent catalyst and/or regenerated catalyst is integrated with the bio-oil separation and recovery units as well as the biomass conversion unit. In this embodiment, the spent catalyst and/or regenerated catalyst may be rejuvenated in-situ with the biomass conversion unit and the bio-oil separation and recovery units wherein one or more flow lines from the bio-oil separation and recovery unit and the biomass conversion unit are fed directly into the rejuvenation unit or indirectly into the rejuvenation unit.

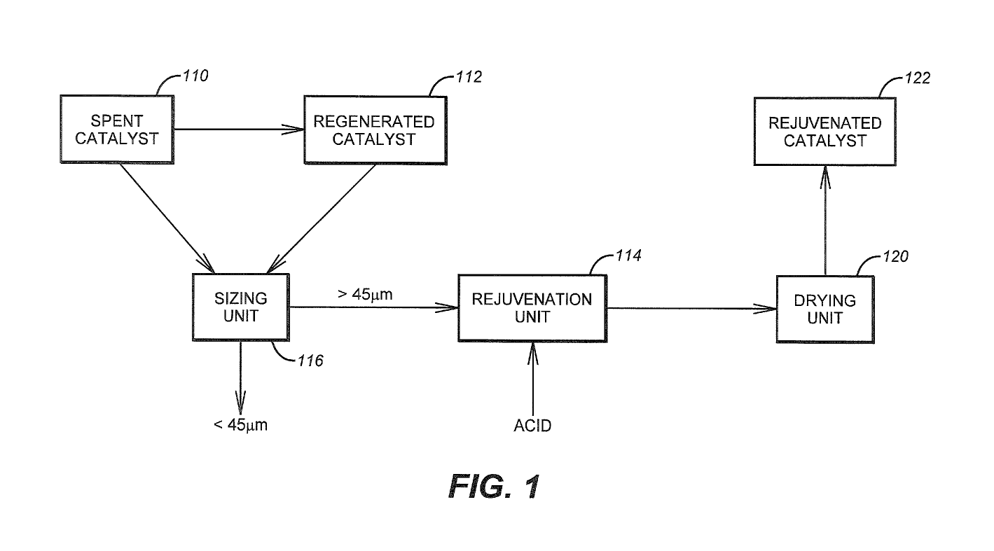

FIG. 1 depicts a process for recovering the physical properties of the metal contaminated catalyst. The biomass conversion unit may be integrated with the rejuvenation unit or rejuvenated catalyst 122 may be located remotely from the biomass conversion unit. The remote location may be off site from where the biomass conversion unit is located or in closer proximity, though not integrated, with the biomass conversion unit. If on site, the process could be integrated with the biomass conversion unit.

As depicted, spent catalyst 110 obtained from a biomass conversion unit may optionally be introduced into catalyst regeneration unit where coke may be burned from the spent catalyst in oxygen or an oxygen containing gas, such as air, to render regenerated catalyst 112. Spent catalyst 110 and/or regenerated catalyst 112 may then be processed in sizing unit 116 to remove fines of smaller particle size from the spent and/or regenerated catalyst. Sizing unit 116 may be any conventional separator such as a filter, electrostatic, magnetic, precipitator, cyclone, density fractionator, size classifier or screen. Typically, fines less than 45 μm and, in some cases fines less than 60 μm, may be removed in sizing unit 116.

The sized product is then introduced into catalyst rejuvenation unit 114 and subjected to an acid wash in order to remove or to disperse or to disassociate contaminant metals from the spent catalyst and/or regenerated catalyst (E-cat).

In an ex-situ process, it is preferred that the acid solution introduced into the rejuvenation unit contains an inorganic acid such as nitric acid, sulfuric acid, phosphoric acid, hydrochloric acid, or a mixture thereof.

After the treated catalyst is dried in drying unit 120, it may then be introduced into a biomass conversion unit. Drying unit 120 may be a conventional dryer, such as rotary, conveyor, flash, belt dryer and the treated catalyst may be subjected to a relatively quick drying stage to reduce water content. Rejuvenated catalyst 122 is optionally—mixed with fresh catalyst for processing biomass in the biomass conversion unit.

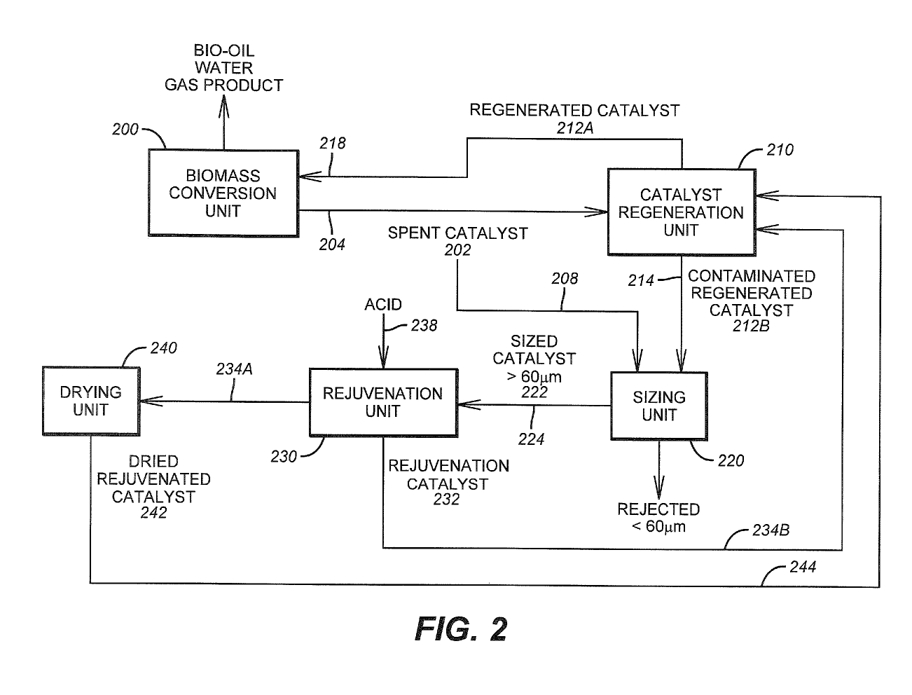

FIG. 2 illustrates an embodiment of the disclosure where rejuvenation of the spent catalyst and/or regenerated catalyst may be integrated (in-situ) with the biomass conversion unit. As shown in FIG. 2, the catalyst rejuvenated in catalyst rejuvenation unit 230 may be a portion or all of the spent catalyst exiting biomass conversion unit 200 or a portion or all of the catalyst regenerated from the spent catalyst 202.

As illustrated, bio-oil, water and gas products produced in biomass conversion unit 200 are removed and feedstream 204 containing spent catalyst 202 may be fed into catalyst regeneration unit 210. Regenerated catalyst 212 from catalyst regeneration unit 210 may then be fed into sizing unit 220 via flow line 214. Alternatively, or in addition to the flow of the regenerated catalyst into the sizing unit, spent catalyst 202 may be fed directly into sizing unit 220 through flow line 208. It is possible that the treated catalyst subjected to sizing unit 220 may be just the spent catalyst 202 or just the regenerated catalyst 212 or a combination of the two.

In the sizing unit, fines (enriched with mineral metals) may be selectively removed from the regenerated catalyst. Typically, fines less than 45 μm are removed during this stage and in some cases particle sizes less than 60 μm are removed.

After being sized, the spent catalyst and/or regenerated catalyst and/or their mixture is mildly washed with an acid by introducing an acid wash into rejuvenation unit 230 through flow line 238. In one of the embodiments, the acid is a dilute inorganic acid. The inorganic acid may be one or more acids selected from nitric acid, sulfuric acid, phosphoric acid, hydrochloric acid, as well mixtures thereof. Alternatively, organic acids may also be used, such as acetic acid, propionic acid, oxalic acid, uronic acid, tartaric acid, humic acid, maleic acid, citric acid, butyric acid and ascorbic acid and mixtures thereof.

All or a portion of 232 rejuvenated catalyst may be fed back into catalyst regeneration unit 210 through flow line 234B for further removal of water, coke and other impurities.

Optionally, all or a portion of rejuvenated catalyst 232 from rejuvenation unit 230 may be fed through flow line 234A from catalyst rejuvenation unit 230 into drying unit 240 to reduce water content. A stream of the catalyst acid washed in rejuvenation unit 230 and then dried in drying unit 240, the dried rejuvenated catalyst 242 may be fed through flow line 244 into catalyst regeneration unit 210.

All or a portion of rejuvenated catalyst 232 and/or all or a portion of dried rejuvenated catalyst 242 will indistinguishably be mixed with the regenerated catalyst 212 that is fed into biomass conversion unit 200 through line 218. Fresh catalyst may optionally be added into the biomass conversion unit via catalyst regeneration unit 210 as well, in order to attain desired activity of the catalyst within the reactor.

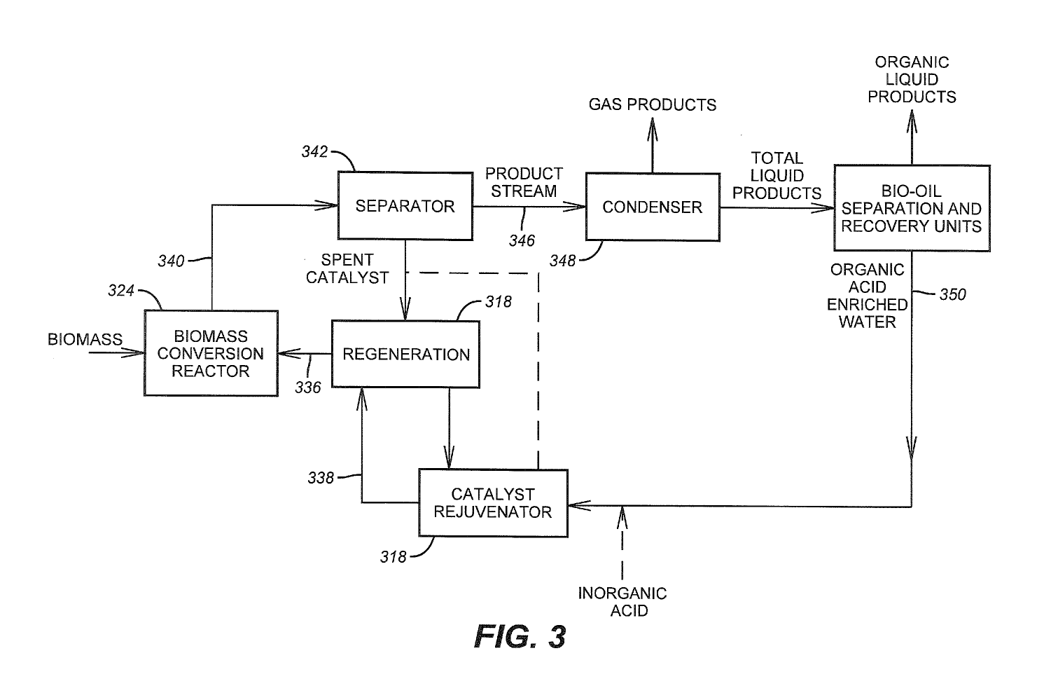

FIG. 3 illustrates an embodiment of the disclosure, wherein rejuvenation of the spent catalyst and/or regenerated catalyst may be integrated with the bio-oil separation and recovery unit as well as the biomass conversion unit. As illustrated, biomass is first introduced into biomass conversion unit 324 which contains biomass conversion catalyst. Conversion effluent from biomass conversion unit 324 may then be fed through flow line 340 into solids separator 342. Solids separator 342 may be any conventional device capable of separating solids from gas and vapors such as, for example, a cyclone separator, a gas filter, or combinations thereof. In solids separator 342, a substantial portion of solids (e.g., spent catalysts, char, and/or heat carrier solids) are removed from the conversion effluent. Spent catalyst containing solid particles recovered in solids separator 342 may be introduced into catalyst regeneration unit 318 where the catalyst may be subjected to combustion. After regeneration, a portion of the hot regenerated solids may be introduced directly into biomass conversion unit 324 via flow line 336.

The substantially solids-free stream separated in solids separator 342 may then be introduced through flow line 346 into condenser 348 and the stream quenched. Non-condensable gases are separated from a total liquid product stream which contains bio-oil; the latter being condensed or partially condensed from vapors in condenser 348.

The total liquid product stream may then be subjected to various bio-oil separation and recovery steps such as fractionation, decanting, centrifugation, desalting, extraction, phase separation, adsorption, reverse osmosis, deoxygenation and hydrotreatment. Organic liquid products containing bio-oil are separated from produced organic acid enriched water in such processes.

For instance, the total liquid product stream may be fed into one or more hydrotreaters in order to remove oxygen from the bio-oil containing stream. The resulting hydrotreated bio-oil stream may then be introduced into a fractionator where and separated into a naphtha fraction, a bio-distillate fraction and a bio-gas oil fraction. Suitable systems to be used in the fractionator include, for example, vacuum distillation, wiped film evaporation, fractional distillation, heated distillation, extraction, membrane separation, partial condensation, and/or non-heated distillation.

The organic acids in the produced acidic water may originate from the biomass feedstream or be a by-product of a chemical reaction occurring within any of the bio-oil separation or recovery units. Such organic acids may include formic, acetic acid, propionic acid, uronic, humic, benzoic as well as mixtures thereof.

The organic acid enriched water may be fed through flow line 350 into catalyst rejuvenation unit 318 where it is used as an acid wash. An external source (i.e., not integrated with either the biomass conversion unit or the bio-oil separation and recovery unit) of a second acid may optionally be fed into flow line 350. Due to costs, such second acids are typically an inorganic acid though organic acids may be used as well. Preferably, such second acids may be an inorganic acid such as nitric acid, sulfuric acid, phosphoric acid, hydrochloric acid, as well as mixtures thereof or an organic acid such as acetic acid, propionic acid, oxalic acid, uronic acid, tartaric acid, humic acid, maleic acid, citric acid, butyric acid and ascorbic acid and mixtures thereof. The acid wash removes, disperses or disassociates metals from the spent catalyst and/or regenerated catalyst. The rejuvenated catalyst is then preferably fed into the biomass conversion unit 324 via the regeneration unit 318 through flow line 338 and then flow line 336. In this manner, fresh catalyst added to biomass conversion unit 324 and the rejuvenated catalyst are heated and thoroughly mixed with the catalyst inventory.

Preferred embodiments of the present disclosure thus offer advantages over the prior art and are well adapted to carry out one or more of the objects of this disclosure. However, the present disclosure does not require each of the components and acts described above and are in no way limited to the above-described embodiments or methods of operation. Any one or more of the above components, features and processes may be employed in any suitable configuration without inclusion of other such components, features and processes. Moreover, the present disclosure includes additional features, capabilities, functions, methods, uses and applications that have not been specifically addressed herein but are, or will become, apparent from the description herein, the appended drawings and claims.

### EXAMPLES

### Example 1

Acid washing solutions were prepared as set forth in Table I below:

TABLE I

| | | | | Molarity |
|---|---|---|---|---|
| Solution | Acid | Wt. % Acid | pH of solution | (moles/L) |
| A | Oxalic | 1 | 5.54 | 0.111 |
| B | Oxalic | 5 | 3.32 | 0.555 |
| C | Oxalic | 10 | 1 | 1.11 |

A regenerated catalyst (E-cat) was generated by burning off coke from a spent zeolitic catalyst. The spent catalyst was used in a thermocatalytic biomass conversion unit used to convert a lignocellulosic material into a bio-oil containing feedstream. A representative comparison of the metal oxide content of the fresh catalyst and the regenerated catalyst is set forth in Table II. A representative comparison of the total surface area (TSA) of the catalyst, the meso surface area (MSA) of the catalyst, the micropore volume, and particle size distribution of the fresh catalyst and the regenerated catalyst is set forth in Table III.

TABLE II

| | SiO2 | Al2O3 | P2O5 | MgO | TiO2 | SO3 | Na2O | CaO | Fe2O3 | K2O | MnO |
|---|---|---|---|---|---|---|---|---|---|---|---|
| Cat | wt % | wt % | wt % | wt % | wt % | wt % | wt % | wt % | wt % | wt % | wt % |
| Fresh | 66.54 | 22.34 | 9.87 | 0.12 | 1.24 | 0 | 0.01 | 0.01 | 0.46 | — | 0 |
| E-cat | 59.7 | 18.43 | 7.86 | 2.13 | 0.92 | 0.06 | 0.94 | 6.28 | 0.6 | 4.16 | 0.31 |

TABLE III

| | TSA | MSA | MiPV | PSD 0-20 | PSD 20-40 | PSD 40-80 | PSD 80-150 | PSD > 150 |
|---|---|---|---|---|---|---|---|---|
| Catalyst | (m2/g) | (m2/g) | (cc/g) | wt % | wt % | wt % | wt % | wt % |
| Fresh | 110.5 | 22.9 | 0.035 | 0 | 3.77 | 31.49 | 46.99 | 17.75 |
| E-cat | 42.4 | 14.5 | 0.014 | 0.76 | 6.69 | 33.24 | 43.83 | 15.48 |

### Example 2

130 grams of regenerated catalyst (E-Cat) was added to 600 mL of each of the acid solutions in Table I at temperature of about 20° C. for about 1 minute. The total surface area (TSA), the meso surface area (MSA), the zeolite surface area (ZSA), and the micropore volume (MiPV) of the rejuvenated catalysts were determined.

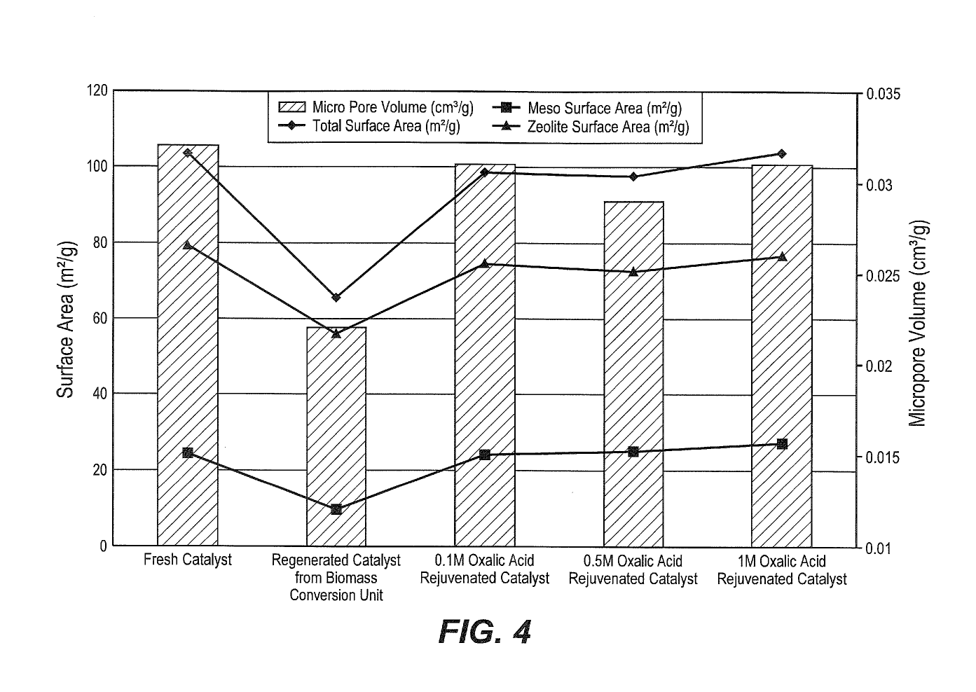

FIG. 4 illustrates that a 1 minute contact time with diluted oxalic acid solution at a liquid:solid ratio of approximately 5:1 was sufficient to unplug the micropores of the regenerated catalyst (E-cat) at various concentrations of oxalic acid washes. For instance, the micropore volume of E-cat as 0.022 cm³/g versus 0.031 cm³/g after the E-cat was treated with 0.1M oxalic solution for 1 minute. This is very close to the 0.032 cm³/g of the fresh catalyst.

### Example 3

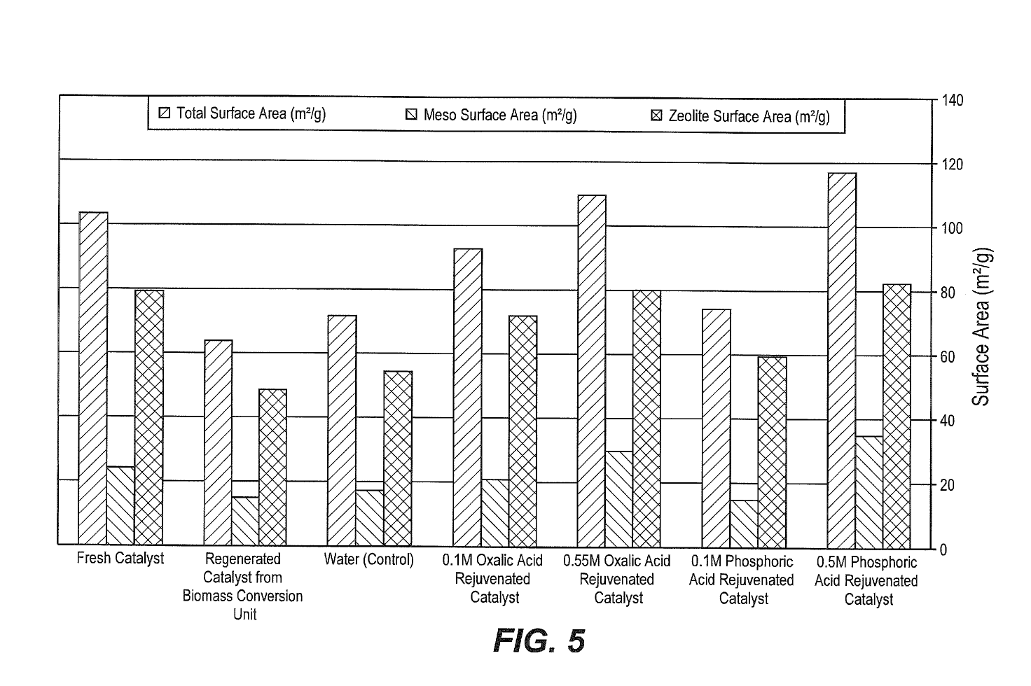

130 grams of regenerated catalyst (E-Cat) was added to 600 mL of each of the acid solutions at temperature of about 20° C. for about 4 hours. The treated catalyst was then recovered and dried. FIG. 5 illustrates that mild acid treatments restore the surface area of the E-cat after the 4 hour treatment. FIG. 5 also illustrates the effect of a 0.1M and 0.5M phosphoric acid wash. Like FIG. 4, FIG. 5 illustrates that both organic acids and inorganic acids are effective in rejuvenating regenerated catalysts by unplugging the micropores that have been blocked by the action of mineral metals originally present in the biomass. Very short acid contact time is sufficient to completely unblocked the plugged micropores and reestablish the surface area to values closed to that of the fresh catalyst.

### Example 4

Micropore plugging of the regenerated catalysts from a biomass conversion unit was observed while the accumulation of mineral metals from biomass in the catalyst inventory took place over time. Complete loss of micropore volume was observed with total contaminant metal oxides level in the catalyst inventory of 28.6%; 75% micropore volume loss was observed at a total contaminant metal oxides level of 23%; 50% micropore volume loss was observed at a total contaminant metal oxides level of 16.4% and 25% micropore volume loss was observed at a total contaminant metal oxides level of 14%.

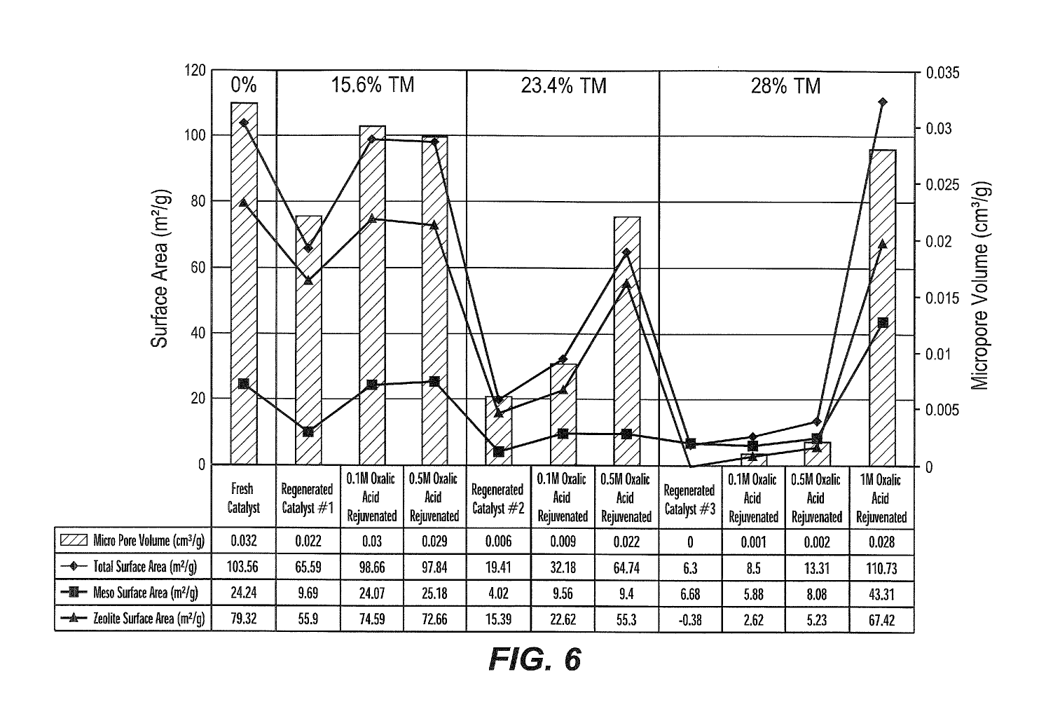

130 grams of each regenerated catalyst (E-Cat), which has a total contaminant metal oxides content of 15.6, 23.4% and 28% respectively, was added to 600 mL of each of the acid solutions in Table I at temperature of about 20° C. for about 1 minute. The micropore volume (MiPV, in cm³/g), the total surface area (TSA), the meso surface area (MSA), the zeolite surface area (ZSA, all surface area values in m²/g) of the catalysts were determined after oxalic acid washes. The results are illustrated in FIG. 6 and illustrate the recovery of the surface area and the micropore volume by means of the acid wash. For instance, FIG. 6 shows a mild acid treatment with oxalic acid at a contact time of 1 minute unblocks the micropores back to fresh values of the zeolite catalyst, so do the surface area-values of the catalysts. For example, for a regenerated catalyst with a 15.6% total contaminant metal oxide content, a 0.1M oxalic acid wash renders a 74.59 m²/g zeolite surface area versus a zeolite surface area of 79.32 m²/g for fresh catalyst and 55.9 m²/g for the regenerated catalyst. Similar results are seen with the micropore volume, the total surface area, and the meso surface area. At 28% total contaminant metal oxide content, the regenerated catalyst has no micropore volume, versus a micropore volume of 0.028 cm³/g after a 1 minute 1M oxalic acid wash, which recovered almost 88% of the micropore volume of the fresh catalyst.

### Example 5

The water product from a biomass conversion unit in general contained acetic acid and propionic acid. Acetic acid solutions at different concentrations in Table III have been used to rejuvenate the regenerated catalyst.

TABLE III

| | | Solid:Liquid | pH before | pH of filtrate, after |
|---|---|---|---|---|
| Solution | Conc. | (vol ratio) | washing | washing |
| D | 0.05M | 1:4.5 | 3.13 | 4.27 |
| E | 0.1M | 1:4.5 | 2.82 | 4.01 |
| F | 0.5M | 1:4.5 | 2.236 | 3.39 |

The regenerated catalyst from a thermocatalytic biomass conversion unit had an approximate 15.6 wt % contaminant metal oxide content. The regenerated catalyst (E-Cat) was added to each of the acid solutions in Table III with the liquid:solid ratio of 4.5 at temperature of about 20° C. for about 1 minute. The micropore volume (in cm³/g), the total surface area, the meso surface area, the zeolite surface area (in m²/g) of the rejuvenated catalysts were determined.

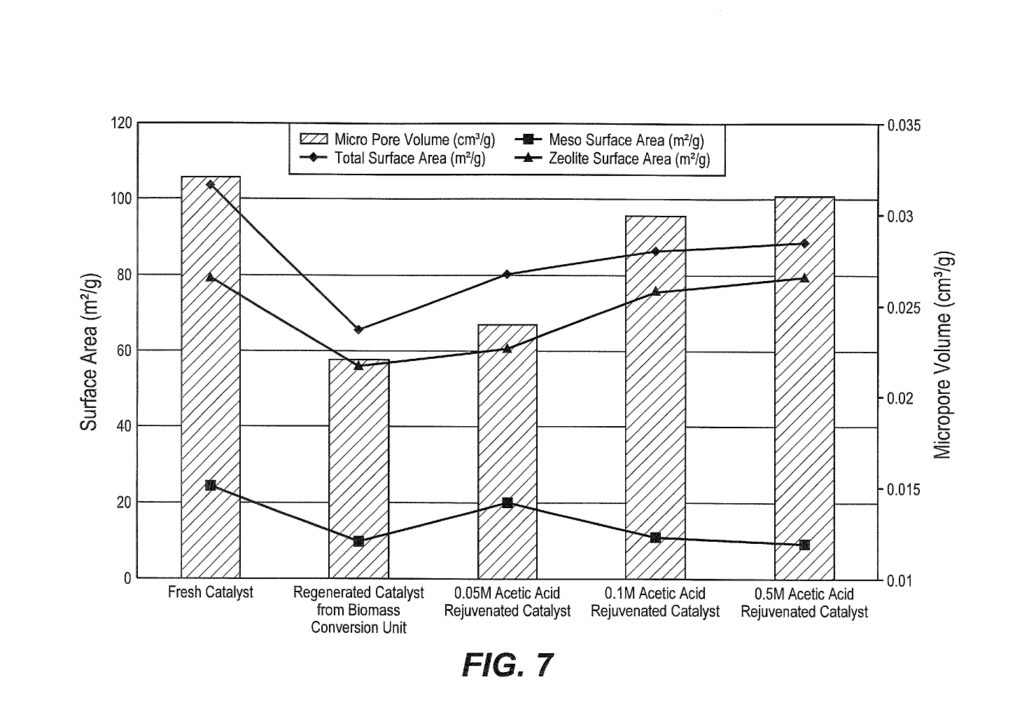

FIG. 7 illustrates that a 1 minute contact time was sufficient to unplug the micropores of the regenerated catalyst at various concentrations of acetic acid wash. For instance, the micropore volumes of the rejuvenated catalysts by using 0.1M and 0.5M acetic acid wash were more than 80% of the micropore volume of the fresh catalyst (0.032 cm³/g). This illustrates that the use of produced acid-enriched water from the biomass conversion unit may be used as an organic acid source to rejuvenate catalyst in a rejuvenation unit integrated with the biomass conversion unit and the bio-oil separation and recovery unit.

### Example 6

Nitric acid solutions were prepared as set forth in Table IV below.

TABLE IV

| | | Solid:Liquid | | |
|---|---|---|---|---|
| Solution | Conc. | (vol ratio) | pH before | pH after |
| G | 0.01M | 1:4.5 | 1.85 | 4.78 |
| H | 0.05M | 1:4.5 | 1.47 | 4.08 |
| I | 0.1M | 1:4.5 | 1.34 | 3.13 |
| J | 0.3M | 1:4.5 | 1.03 | 3.00 |
| J | 0.5M | 1:4.5 | 0.8 | 1.23 |

The regenerated catalyst from a thermocatalytic biomass conversion unit had an approximate 15.6 wt % contaminant metal oxide content. The regenerated catalyst (E-Cat) was added to each of the acid solutions in Table IV with the liquid:solid ratio of 4.5 at temperature of about 20° C. for about 1 minute. The micropore volume (in cm³/g), the total surface area, the meso surface area, the zeolite surface area (in m²/g) of the rejuvenated catalysts were determined.

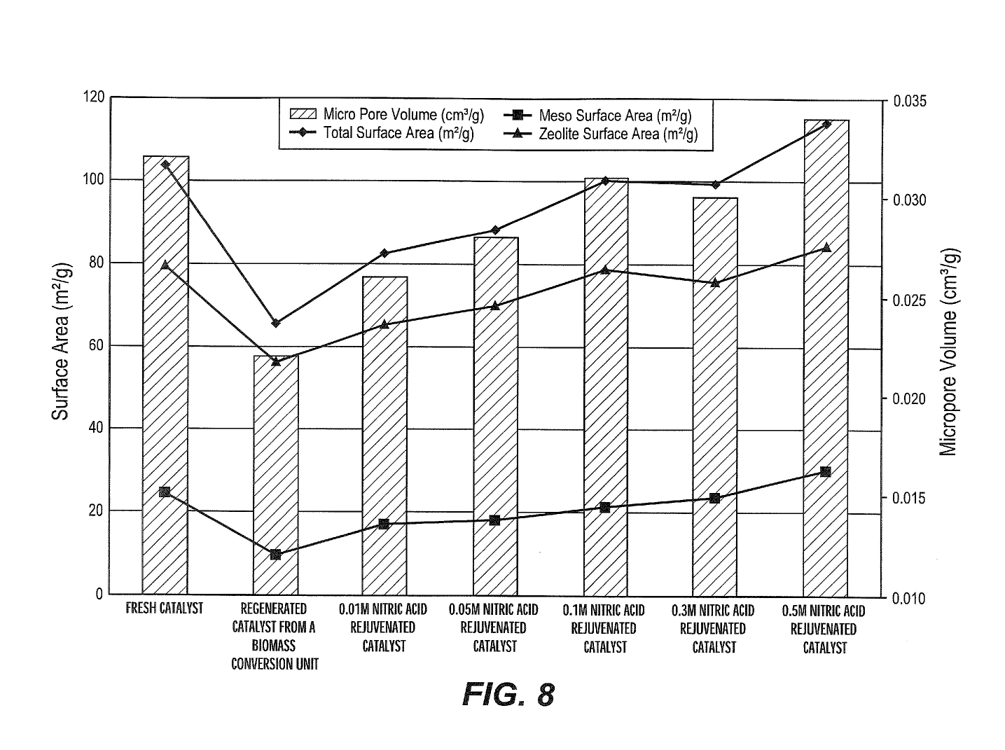

FIG. 8 illustrates that a 1 minute contact time was sufficient to unplug the micropores of the regenerated catalyst at various concentrations of nitric acid wash. For instance, the micropore volumes of the rejuvenated catalysts by using 0.05M, 0.1M and 0.3M nitric acid wash were more than 80% of micropore volume of the fresh catalyst (0.032 cm³/g).

### Example 7

Two water samples produced in a biomass conversion unit were obtained. The chemical analysis showed that the water products contain acetic acid, propionic acid, and some other organic compounds. The physical properties of the water samples is set forth in Table V:

TABLE V

| | Water | Water |
|---|---|---|
| | product #1 | product #2 |
| Density @ 60 F., g/m L | 1.0087 | 1.0251 |
| CARBON, wt % | 6.93 | 7.957 |
| HYDROGEN, wt % | 10.57 | 10.125 |
| NITROGEN, wt % | 0.2 | 0.123 |
| pH | 4.233 | 3.823 |

The regenerated catalyst from a thermocatalytic biomass conversion unit had an approximate 18.9 wt % contaminant metal oxide content. The regenerated catalyst (E-Cat) was sieved to remove the fines, and then added to each of the water products in Table V with the liquid:solid ratio of 4.5 at temperature of about 20° C. for about 1 minute. The micropore volume (in cm³/g), the total surface area, the meso surface area, the zeolite surface area (in m²/g) of the rejuvenated catalysts were determined.

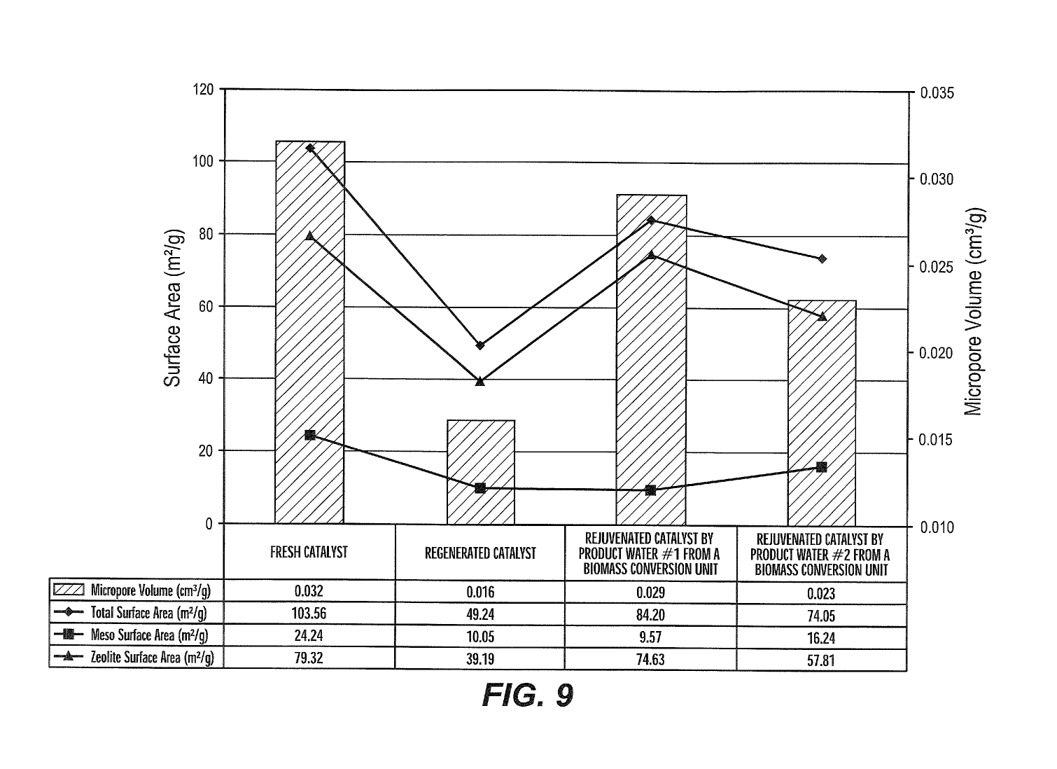

FIG. 9 illustrates that a 1 minute contact time was sufficient for each of the produced water samples from the biomass conversion unit to recover at least 80% of the micropore volume of that of the fresh catalyst.

The methods that may be described above or claimed herein and any other methods which may fall within the scope of the appended claims can be performed in any desired suitable order and are not necessarily limited to any sequence described herein or as may be listed in the appended claims. Further, the methods of the present disclosure do not necessarily require use of the particular embodiments shown and described herein, but are equally applicable with any other suitable structure, form and configuration of components.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of appended claims. Thus, all matter herein set forth or shown in the accompanying drawings should be interpreted as illustrative, and the scope of the disclosure and the appended claims should not be limited to the embodiments described and shown herein.

What is claimed is:

1. A method of rejuvenating a spent catalyst or a regenerated catalyst from a biomass conversion unit comprising treating at least a portion of the spent catalyst or regenerated catalyst with an acid solution treatment, comprising an inorganic acid or an organic acid or a mixture thereof.

2. The method of claim 1, wherein the catalyst comprises zeolite.

3. The method of claim 1, wherein the catalyst is a regenerated catalyst.

4. The method of claim 1, wherein the treatment acid is an inorganic acid.

5. The method of claim 1, wherein the treatment acid is an organic acid.

6. The method of claim 4, wherein the inorganic acid is selected from the group consisting of nitric acid, sulfuric acid, phosphoric acid, hydrochloric acid, and mixtures thereof.

7. The method of claim 5, wherein the organic acid is selected from the group consisting of acetic acid, propionic acid, oxalic acid, uronic acid, tartaric acid, humic acid, maleic acid, citric acid, butyric acid and ascorbic acid and mixtures thereof.

8. The method of claim 7, wherein the organic acid is selected from the group consisting of acetic acid and propionic acid and mixtures thereof.

9. The method of claim 1, wherein biomass feed treated in the biomass conversion unit comprises a lignocellulosic material.

10. The method of claim 5, wherein rejuvenation of the spent catalyst or regeneration catalyst occurs in a rejuvenation unit, the rejuvenation unit being integrated in-situ with the biomass conversion unit.

11. The method of claim 5, wherein the treatment acid is within an organic acid enriched stream and further wherein (i) the organic acid enriched stream is separated from bio-oil in a bio-oil separation and recovery unit and (ii) the bio-oil separation and recovery unit is integrated in-situ with the biomass conversion unit.

12. The method of claim 11, further comprising adding a second acid to the spent catalyst or regenerated catalyst in the rejuvenation unit, wherein the source of the second acid is not integrated with the biomass conversion unit and the bio-oil separation and recovery unit.

13. The method of claim 12, wherein the second acid is an organic acid selected from the group consisting of acetic acid, propionic acid, oxalic acid, uronic acid, tartaric acid, humic acid, maleic acid, citric acid, butyric acid and ascorbic acid and mixtures thereof.

14. The method of claim 13, wherein the second acid is an inorganic acid selected from the group consisting of nitric acid, sulfuric acid, phosphoric acid, hydrochloric acid, and mixtures thereof.

15. The method of claim 1, wherein rejuvenation of the spent catalyst or regeneration catalyst occurs in a rejuvenation unit, the rejuvenation unit being located ex-situ from the biomass conversion unit.

16. The method of claim 1, wherein the spent catalyst or regenerated catalyst is rejuvenated by:
(a) removing fines from the spent catalyst or regenerated catalyst;
(b) washing the particles of the product of step (a) in the presence of the treatment acid; and
(c) drying the product of step (b).

17. The method of claim 16, wherein the catalyst is a regenerated catalyst.

18. The method of claim 16, wherein the fines have a particle size less than or equal to 60 μm.

19. The method of claim 18, wherein the fines have a particle size less than or equal to 45 μm.

20. The method of claim 16, wherein the treatment acid is an inorganic acid.

21. The method of claim 16, wherein the treatment acid is an organic acid.

22. The method of claim 21, wherein rejuvenation of the spent catalyst or regeneration catalyst is integrated in-situ with the biomass conversion unit.

23. The method of claim 22, wherein the treatment acid is within an organic acid enriched stream and further wherein (i) the organic acid enriched stream is separated from bio-oil in a bio-oil separation and recovery unit and (ii) the bio-oil separation and recovery unit is integrated in-situ with the biomass conversion unit.

24. The method of claim 23, wherein the organic acid of the organic acid enriched stream is selected from the group consisting of acetic acid and propionic acid and mixtures thereof.

25. The method of claim 23, further comprising adding a second acid to the spent catalyst or regenerated catalyst wherein the source of the second acid is not integrated with the biomass conversion unit and the bio-oil separation and recovery unit.

26. The method of claim 25, wherein the second acid is an inorganic acid.

27. The method of claim 26, wherein the inorganic acid is selected from the group consisting of nitric acid, sulfuric acid, phosphoric acid, hydrochloric acid, and mixtures thereof.

28. The method of claim 26, wherein the second acid is an organic acid selected from the group consisting of acetic acid, propionic acid, oxalic acid, uronic acid, tartaric acid, humic acid, maleic acid, citric acid, butyric acid and ascorbic acid and mixtures thereof.

29. A method of rejuvenating a spent catalyst or a regenerated catalyst from a biomass conversion unit comprising:
(a) transporting the spent catalyst or regenerated catalyst to an area remote from the biomass conversion unit;
(b) treating at least a portion of the spent catalyst or regenerated catalyst with a treatment acid, the treatment acid comprising an inorganic acid; and
(c) removing or disassociating from the spent catalyst or regenerated catalyst at least one metal selected from the group consisting of calcium, magnesium, sodium, manganese, potassium, aluminum, silicon, chromium, chlorine and iron.

30. The method of claim 29, wherein the catalyst is a regenerated catalyst.

31. The method of claim 29, wherein the treatment acid is an inorganic acid.

32. The method of claim 31, wherein the inorganic acid is selected from the group consisting of nitric acid, sulfuric acid, phosphoric acid, hydrochloric acid, and mixtures thereof.

33. The method of claim 29, wherein step (b) comprises:
(i) removing fines from the spent catalyst or regenerated catalyst;
(ii) washing the particles of the product of step (i) in the presence of the treatment acid; and
(iii) drying the product of step (ii).

34. The method of claim 33, wherein the fines have a particle size less than or equal to 60 μm.

35. The method of claim 34, wherein the fines have a particle size less than or equal to 45 μm.

36. A method of rejuvenating a spent catalyst or a regenerated catalyst from a biomass conversion unit, wherein the method is conducted in a treatment unit comprising the biomass conversion unit, a bio-oil separation and recovery unit, and a catalyst rejuvenation unit, the method comprising:
(a) subjecting biomass to pyrolysis in the presence of a catalyst in the biomass conversion unit and generating a bio-oil containing feedstream and spent catalyst;
(b) optionally subjecting the spent catalyst to regeneration;
(c) separating bio-oil and acid enriched water from the bio-oil containing feedstream;
(d) introducing into the catalyst rejuvenation unit at least a portion of the spent catalyst of step (a) or the regenerated catalyst of step (b);
(e) treating the spent catalyst or the regenerated catalyst in the catalyst rejuvenation unit with the acid enriched water and removing or disassociating metals from the spent catalyst or regenerated catalyst to render a rejuvenated catalyst.

37. The method of claim 36, further comprising introducing the rejuvenated catalyst of step (e) to the biomass conversion unit.

38. The method of claim 36, wherein the acid of the acid enriched water is acetic acid or propionic acid or a mixture thereof.

39. The method of claim 36, further comprising adding a second acid from an external source to the rejuvenation unit.

40. The method of claim 39, wherein the second acid is an inorganic acid.

41. The method of claim 40, wherein the inorganic acid is selected from the group consisting of nitric acid, sulfuric acid, phosphoric acid, hydrochloric acid, and mixtures thereof.

42. The method of claim 39, wherein the second acid is an organic acid selected from the group consisting of acetic acid, propionic acid, oxalic acid, uronic acid, tartaric acid, humic acid, maleic acid, citric acid, butyric acid and ascorbic acid and mixtures thereof.

43. The method of claim 36, wherein, during rejuvenation, calcium, magnesium, sodium, manganese, potassium, aluminum, silicon, chromium, chlorine and/or iron minerals are removed, dispersed or disassociated from the spent catalyst or regenerated catalyst.

44. The method of claim 36, wherein step (e) comprises:
(i) removing fines from the spent catalyst or regenerated catalyst;
(ii) washing the particles of the product of step (i) in the presence of the treatment acid; and
(iii) drying the product of step (ii).

45. The method of claim 44, wherein the fines have a particle size less than or equal to 60 μm.

46. The method of claim 45, wherein the fines have a particle size less than or equal to 45 μm.

47. A method of rejuvenating a spent catalyst or a regenerated catalyst from a biomass conversion unit comprising:
(a) circulating in a biomass conversion unit fresh biomass conversion catalyst and a biomass feed containing mineral metals;
(b) generating spent catalyst in the biomass conversion unit from accumulation of the mineral metals in the catalyst inventory;
(c) optionally subjecting the spent catalyst to regeneration;
(d) treating at least a portion of the spent catalyst and/or regenerated catalyst with a solution comprising an inorganic acid or an organic acid or a mixture thereof and removing, dispersing or disassociating contaminant metals from at least a portion of the spent catalyst and/or regenerated catalyst to render a rejuvenated catalyst.

48. The method of claim 47, wherein treatment step (d) occurs when the accumulated mineral metals are less than 50 volume percent of the catalyst inventory.

49. The method of claim 48, wherein the accumulated mineral metals in the catalyst inventory include at least one member selected from the group consisting of calcium, potassium, magnesium, manganese, sodium, aluminum, silicon, chromium, chlorine and iron.

50. The method of claim 47, wherein the micropore volume or micropore area of the spent or regenerated catalyst in step (d) has been reduced in more than 50% of the fresh biomass cracking catalyst.

51. The method of claim 47 wherein the micropore volume or the micropore area of the rejuvenated catalyst is at least 80% of the micropore volume or the micropore area of the fresh biomass cracking catalyst.
